(19) United States
(12) Patent Application Publication
(10) Pub. No.: US 2009/0095880 A1
(43) Pub. Date: Apr. 16, 2009

(54) Autofocus control circuit, autofocus control method and image pickup apparatus

(75) Inventor: Takeshi Otsuki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/285,298

(22) Filed: Oct. 1, 2008

(30) Foreign Application Priority Data
Oct. 16, 2007 (JP) 268537/2007

(51) Int. Cl. G02B 7/04

(52) U.S. Cl. 250/201.2

(57) ABSTRACT

The invention aims to reduce, in performing autofocusing on an autofocus target region determined within a face region obtained by face detection, the risk of misfocusing attributable to a background image included in the autofocus target region. To this end, a face detecting unit firstly performs face detection to determine a face region including a human face image. Then, an AF target region determination unit determines an AF target region within the face region. In this event, the AF target region determination unit can change the area ratio of the AF target region to the face region. Thereafter, based on contrast of a region, corresponding to the AF target region determined by the AF target region determination unit, of captured image data, an AF evaluation value calculation unit, a controller and a lens driving unit adjust a location where a subject image is formed by a shooting optical system.

### BACKGROUND OF THE INVENTION

1. Field of the Invention

The present invention relates to an image pickup apparatus, especially to an autofocus technique of automatically determining a focusing condition of a subject image in an image pickup apparatus.

2. Description of the Related Art

Heretofore, image pickup apparatuses each including an image pickup device such as a charge coupled device (CCD) sensor or a complementary metal oxide semiconductor (CMOS) sensor has been put to practical use. Examples of such image pickup apparatuses are a digital still camera and a digital video camera. In addition, as an autofocus system applied to these electronic image pickup apparatuses, a contrast detection system based on an image captured by an image pickup device is known.

The contrast detection system is based on the principle that when a subject image formed onto an imaging surface of an image pickup device by a shooting optical system is in an in-focus condition, the image pickup device can capture a high contrast image. Specifically, in the contrast detection system, firstly, an image pickup device of an image pickup apparatus sequentially captures images of a subject while changing an imaging location of an image of the subject. Here, the changing of the imaging location is achieved by moving a focusing lens included in a shooting optical system, or by moving the image pickup device. Then, the image pickup apparatus calculates contrast evaluation values respectively indicating contrast levels of the multiple images sequentially captured by the image pickup device, and determines, as an in-focus location, an imaging location of the subject image where the contrast evaluation value is the highest. As a contrast evaluation value, the total value of high-frequency components in a spatial frequency spectrum of a captured image is used, for example. A control algorithm to determine an in-focus location by searching the highest contrast evaluation value as described above is called as “hill-climbing control.”

Meanwhile, image pickup apparatuses are known each of which performs face detection for detecting a human face image included in an image captured by an image pickup device, and which performs focusing control such that the detected face image can come into focus (refer to Japanese Patent Application Publications Nos. 2001-215403 and 2006-227080, for example).

Note that various face detection algorithms-for detecting a face image included in a captured image are already known. For example, one of these known algorithms is an algorithm which extracts, from an image, regions evaluated to have skin tones, and which determines, as a face region, a cluster of the regions evaluated to have skin tones. Meanwhile, a face detection algorithm using a known pattern recognition technique is also known. Specifically, for example, in one of these known algorithms, a contour of a region evaluated to have skin tones in an image is compared with a face line template, which is previously learned. Then, a face region is determined based on the similarity level as a result of the comparison. For example, in another one of these known algorithms, a region evaluated to have skin tones is set as a face candidate, and feature quantities corresponding to eyes and a nose are extracted from this face candidate region. Then, by comparing the extracted feature quantities with feature quantities of multiple face template images, it is determined whether or not the face candidate is a human face.

Japanese Patent Application Publication No. 2001-215403 (hereinafter, referred to as Patent Document 1) discloses a camera which performs autofocusing by using an image pickup device such as a CCD. Patent Document 1 aims to solve the problem that, the contrast detection system as described above “is unstable since, with this system, not a subject but its background or its clothing might come into focus, and thus cannot surely and automatically focus on a location that a camera operator desires” (refer to paragraph [0014] of Patent Document 1). To this end, the camera disclosed in Patent Document 1 firstly determines a region (hereinbelow, referred to as face region) including a human face by performing face detection on an image captured by an image pickup device, and then detects human eyes from the face region. The camera disclosed in Patent Document 1 firstly calculates a distance to a point corresponding to the position of the detected human eyes by using the known principle of triangulation. Then, the camera disclosed in Patent Document 1 performs focusing control so as to focus on the human eyes of the subject by using the calculated distance to the point corresponding to the position of the human eyes. As is clear from the above description, the autofocus system on which the camera disclosed in Patent Document 1 is based is not a contrast detection system.

Japanese Patent Application Publication No. 2006-227080 (hereinafter, referred to as Patent Document 2) discloses a digital camera having an autofocus function. Patent Document 2 aims to solve the problem that autofocus control performed by the camera disclosed in Patent Document 1 has difficulty in automatically focusing on the eyes of a human subject when the human subject closes his or her eyes or wears glasses (refer to paragraphs [0002] and [0003] of Patent Document 2). To this end, the digital camera disclosed in Patent Document 2 determines a region including a human face (that is, a face region) by performing face detection on a captured image outputted by an image pickup device, and determines, as an autofocus target region, a rectangular region including the determined face region and its periphery so that the of the detected human face can be included in the autofocus target region. Then, the digital camera disclosed in Patent Document 2 determines an in-focus location where the contrast evaluation value for the autofocus target region in the captured image is the highest. In other words, the digital camera disclosed in Patent Document 2 performs a focusing control on the basis of contrast in a portion around a face line. As a result, a partial image determined as an autofocus target region inevitably includes a background image in addition to the face line portion of the face.

Meanwhile, Japanese Patent Application Publication No. Hei 5-66458 (hereinafter, referred to as Patent Document 3) discloses a camera which measures a brightness of a subject by using an image pickup device such as a CCD. On the finder window of the camera disclosed in Patent Document 3, a target mark is displayed, and a camera operator controls the direction of the camera such that a human face can overlap the target mark displayed on the finder window of the camera (refer to paragraph [0008] of Patent Document 3). Then, the camera disclosed in Patent Document 3 measures a distance to a target overlapping with the target mark by using an active distance sensor, and calculates the face size of a subject on the basis of the measured distance and information on an average face size (refer to paragraphs [0008] and [0009] of Patent Document 3). Thereafter, the camera disclosed in Patent Document 3 performs light metering in a light metering region determined as a rectangular region with an area size nearly covering a face on the basis of the calculated face size. In this event, the size of the exposure measurement region should preferably be a certain percentage of the face size so that exposure will not be measured on background (paragraph [0012] of Patent Document 3). However, the camera disclosed in Patent Document 3 neither performs face detection by performing image processing on a captured image nor performs autofocusing on a detected face region.

Among the above Patent Documents 1 to 3, only Patent Document 2 discloses an image pickup apparatus which performs autofocusing based on the contrast detection system. However, the image pickup apparatus disclosed in Patent Document 2 adjusts an imaging location of a subject image mainly on the basis of contrast in a portion around a face line. Accordingly, the autofocus target region determined by the image pickup apparatus disclosed in Patent Document 2 includes a background image in addition to a human face image. Note that, the autofocus target region means a contrast-detection-target region for autofocusing.

Determining an autofocus target region so as to include a periphery portion of a face region and a background image around the face region as described above, the technique disclosed in Patent Document 2 has a problem of having a strong risk of causing misfocusing, a phenomenon that, if background occupies a large percentage of the autofocus target region, the background will come into focus while a human face is out of focus. This misfocusing risk is particularly prominent when a human subject is near the camera and thus a face region occupies a large percentage of the entire area of a captured image. This is because, when a human subject is near the camera, an autofocus target region includes a large area of background and, moreover, the human subject is distant from the background.

Moreover, the size of a face image included in a captured image, that is, the size of a face region, is supposed to change in accordance with photographing conditions. Meanwhile, in many techniques, a face region is selected as a rectangular region including a human face as disclosed in Patent Document 2. As a result, the larger the face region is, the larger background portion is included therein. Thus, an autofocus target region selected to include a face line by a technique disclosed in Patent Document 2 is likely to include a large background portion, too.

As described above, the image pickup apparatus disclosed in Patent Document 2 has a problem of having a strong risk of misfocusing due to a background image included in an autofocus target region.

### SUMMARY

An autofocus control circuit according to a first aspect of the present invention includes face detection means, autofocus target region determination means and focusing condition determination means. The face detection means determines a face region including a face of a subject within an image of the subject on the basis of captured image data generated by capturing the subject image formed by a shooting optical system. The autofocus target region determination means determines an autofocus target region within the face region. In this event, the autofocus target region determination means can change an area ratio of the autofocus target region to the face region. The focusing condition determination means determines a focusing condition of the subject image on the basis of contrast in a region, corresponding to the autofocus target region, of the captured image data.

A method according to a second aspect of the present invention is an autofocus control method for an image pickup apparatus including image pickup means for generating captured image data by capturing an image of a subject formed by a shooting optical system. The method including the steps of: determining a face region including a face of the subject within the subject image on the basis of the captured image data; determining an autofocus target region within the face region by changing an area ratio of the autofocus target region to the face region; and adjusting an imaging location of the subject image on the basis of contrast in a region, corresponding to the autofocus target region, of the captured image data.

An image pickup apparatus according to a third aspect of the present invention includes a shooting optical system, image pickup means, face detection means, autofocus target region determination means and autofocus means. The image pickup means generates captured image data by capturing an image of the subject formed by a shooting optical system. The face detection means determines a face region including a face of the subject within the subject image on the basis of the captured image data. The autofocus target region determination means determines an autofocus target region within the face region. In this event, the autofocus target region determination means can change an area ratio of the autofocus target region to the face region. The autofocus means adjusts an imaging location of the subject image on the basis of contrast in a region, corresponding to the autofocus target region, of the captured image data.

In a face region, a region most likely to include a background image is a periphery portion of the face region. Thus, the autofocus control circuit, the autofocus control method and the image pickup apparatus according to the respective aspects of the present invention described above each selects, as an autofocus target region, a center portion other than a periphery portion of a face region. This makes it possible to select the autofocus target region while effectively excluding a background portion included in the face region. In other words, the autofocus control circuit, the autofocus control method and the image pickup apparatus according to the respective aspects of the present invention each makes it possible to perform autofocusing on the basis of contrast in an autofocus target region including no or a relatively small background portion. This reduces the risk of accidentally focusing on background and thus enables the capturing of images focusing on human faces.

In addition, the autofocus control circuit, the autofocus control method and the image pickup apparatus according to the respective aspects of the present invention described above are each capable of changing the area ratio of an autofocus target region to a face region. This enables operations including: setting the area size of the autofocus target region to a constant value irrespective of the size of the face region; and increasing the area size of a periphery portion of the face region excluded from the autofocus target region with the increase in the size of the face region. Thus, the autofocus target region can be selected while effectively excluding a background image included in the face region.

The present invention can reduce the risk of misfocusing in performing autofocusing on an autofocus target region determined within a face region obtained by face detection. Here, the misfocusing is attributable to a background image included in the autofocus target region.

Note that, in the case of performing autofocusing based on the contrast detection system, with the decrease in the area size of the face region, background portions included in a face region and an autofocus target region become smaller, and thus the risk of misfocusing, that is, accidentally focusing on background, is supposed to be reduced. However, in this case, there is a problem that, since the face region is small, the autofocus target region for contrast detection might be too small for reliable contrast evaluation and thus the risk of failing to autofocus is increased.

To address this problem, the autofocus control circuit, the autofocus control method and the image pickup apparatus according to the respective aspects of the present invention described above should preferably change the area ratio of an autofocus target region to a face region on the basis of the size of the face region. This allows the reduction of the area ratio of an autofocus target region to a face region when the area ratio of the face region to a captured image is high. Thus, the risk of accidentally focusing on background can be reduced since such reduction of the area ratio allows effective exclusion of a background portion from the autofocus target region. On the other hand, the above characteristics allow the increase of the area ratio of an autofocus target region to a face region when the area ratio of the face region to a captured image is low. Thus, the risk that too small autofocus target region causes failure of autofocus based on the contrast detection system can be reduced.

Meanwhile, the image pickup apparatus disclosed in Patent Document 2 selects a rectangular region including a face line portion of a face from multiple rectangular regions (focus detection areas in Patent Document 2) arranged regularly in a captured image plane, on the basis of a result of face detection. Then, the image pickup apparatus sets the selected region as an autofocus target region (designated area in Patent Document 2). Accordingly, the image pickup apparatus disclosed in Patent Document 2 can reduce a background image in an autofocus target region of an image only when the image is captured under the condition that any of rectangular regions arranged regularly in a captured image plane is largely occupied by a human subject's face image including his/her face line. However, such a condition will be provided only by chance. To reduce a background image in an autofocus target region without relying on such a chance condition, each of the multiple rectangular regions must be reduced in size so that a captured image can be divided into more pieces. However, this approach has a disadvantage of increasing computational complexity required in determining the autofocus target region.

To address this problem, the autofocus control circuit, the autofocus control method and the image pickup apparatus according to the respective aspects of the present invention described above should preferably set the autofocus target region to a region obtained by reducing the face region in accordance with the area ratio. This makes it possible to set a center portion other than a periphery portion of the face region as an autofocus target region, and thus allows the area ratio of a background image in the autofocus target region to the autofocus target region to be effectively reduced without increasing computational complexity, for the background image is likely to be included in the periphery portion of the face region.

### BRIEF DESCRIPTION OF THE DRAWINGS

FIG. 1 is a block diagram showing an image pickup apparatus according to a first embodiment of the present invention.

FIG. 2 is a flowchart showing a procedure of an autofocus process performed by the image pickup apparatus according to the first embodiment of the present invention.

FIGS. 3A and 3B illustrate a relationship between a face region and an autofocus target region in the image pickup apparatus according to the first embodiment of the present invention.

FIGS. 4A and 4B illustrate a relationship between a face region and an autofocus target region in the image pickup apparatus according to the first embodiment of the present invention.

FIG. 5 shows a configuration example of the image pickup apparatus according to the first embodiment of the present invention.

FIG. 6 is a flowchart showing a procedure of an autofocus process performed by an image pickup apparatus according to a second embodiment of the present invention.

FIG. 7 is a graph showing an area size relationship between a face region and an autofocus target region in the image pickup apparatus according to the second embodiment of the present invention.

### DESCRIPTION OF THE PREFERRED EMBODIMENTS

Hereinafter, detailed description will be given of specific embodiments as applications of the present invention with reference to the drawings. In the drawings, the same constituents are denoted by the same reference numerals, and redundant description thereof will be omitted as needed, for clarity of illustration.

### First Embodiment

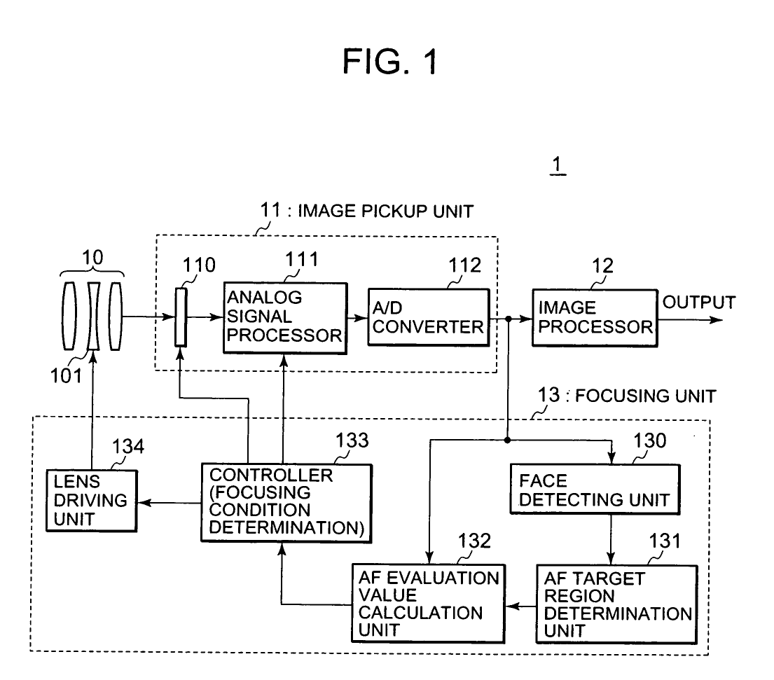

FIG. 1 is a block diagram showing a main configuration of an image pickup apparatus 1 according to a first embodiment. Hereinbelow, constituents included in FIG. 1 are each described. In FIG. 1, a shooting optical system 10 is a set of optical lenses used for forming a subject image on an imaging surface of an image pickup device 110 to be described later. The shooting optical system 10 includes a focusing lens 101. The focusing lens 101 is driven by driving force of a lens driving unit 134 to be described later, and thus is movable in a direction of the optical axis connecting the shooting optical system 10 and the image pickup device 110.

An image pickup unit 11 includes the image pickup device 110, an analog signal processor 111 and an A/D converter 112. The image pickup device 110 is a sensor which photoelectrically converts optical signals incident thereon through the shooting optical system 10 to output the resultant signals as analog image signals. The image pickup device 110 is such a sensor as a charge coupled device (CCD) image sensor or a complementary MOS (CMOS) image sensor, for example.

The analog signal processor 111 processes the analog image signals outputted by the image pickup device 110, by amplifying the signals, removing noise from the signals and the like. The A/D converter 112 samples the analog image signals outputted by the analog signal processor 111 to generate captured image data as digital image signals.

An image processor 12 performs, on the captured image data supplied by the A/D converter 112, image processing such as color correction, white balance adjustment and gamma correction.

A focusing unit 13 performs an autofocus process based on a contrast detection system on the captured image data. Specifically, the focusing unit 13 firstly performs a face detection for detecting a human face included in the captured image generated by the image pickup unit 11. When detecting a human face, the focusing unit 13 then determines, as an autofocus target region (hereinbelow, referred to as AF target region), an area inside a face region in which the human face occupies. Thereafter, the focusing unit 13 moves the focusing lens 101 in the optical axial direction so as to maximize contrast in a region, corresponding to the AF target region, of the captured image data.

In the configuration example shown in FIG. 1, a focusing unit 13 includes a face detecting unit 130, an AF target region determination unit 131, an AF evaluation value calculation unit 132, a controller 133 and the lens driving unit 134. The face detecting unit 130 detects a face region from the captured image generated by the image pickup unit 11 by using the known face detection algorithm described above as a related art.

Based on the size of the face region detected by the face detecting unit 130, the AF target region determination unit 131 determines a region within the face region as an AF target region. The size of the face region may be evaluated based on its area size, for example. If the face region is rectangular, the size thereof may alternatively be evaluated based on its horizontal and vertical lengths. Incidentally, some face detection algorithms perform face detection by dividing a captured image screen into multiple small regions and by determining whether or not each small region corresponds to at least part of a human face on the basis of pixel values of pixels included in the small region. If such face detection algorithm is employed, the size of the face region may be evaluated based on the number of small regions included in the face region. Note that a computation procedure by which the AF target region determination unit 131 determines the AF target region will be described later.

The AF evaluation value calculation unit 132 calculates, as an AF evaluation value, a contrast evaluation value at least on the region, corresponding to the AF target region, of the captured image data. As the contrast evaluation value, any of various parameters can be used as long as the parameter represents the contrast level of the captured image. For example, spatial-frequency spectrum of the AF target region may be obtained by discrete cosine transform (DCT), and magnitude of high-frequency components in the spatial frequency spectrum may be used as the contrast evaluation value. Alternatively, for each pixel in the AF target region, pixel value differences (absolute values) between the pixel and its horizontally and vertically adjacent pixels may be calculated, and the total value obtained by adding up the pixel value differences of the pixels in the AF target region may be used as the contrast evaluation value.

The controller 133 determines focusing conditions on the imaging surface of the image pickup device 110 by using the AF evaluation values calculated by the AF evaluation value calculation unit 132, and thereby determines a position of the focusing lens 101 to provide an in-focus condition. Specifically, the controller 133 causes the image pickup unit 11 to sequentially capture images while moving the focusing lens 101, and thus determines the position of the focusing lens 101 where the AF evaluation value is the highest. Here, a technique of estimating the in-focus location may be applied to an algorithm used when the controller 133 seeks an in-focus location. In this technique, the in-focus location where the image contrast is the highest is estimated by approximating the relation between a position of the focusing lens 101 and an AF evaluation value using an approximate curve such as a Gaussian curve or a quadric curve, or a characteristic curve based on an experiment. The algorithm used when the controller 133 determines focusing conditions by using the contrast evaluation values is not limited to these specific examples, but any of various known algorithms may be used.

The lens driving unit 134 moves the focusing lens 101 in the optical axial direction, under the control of the controller 133.

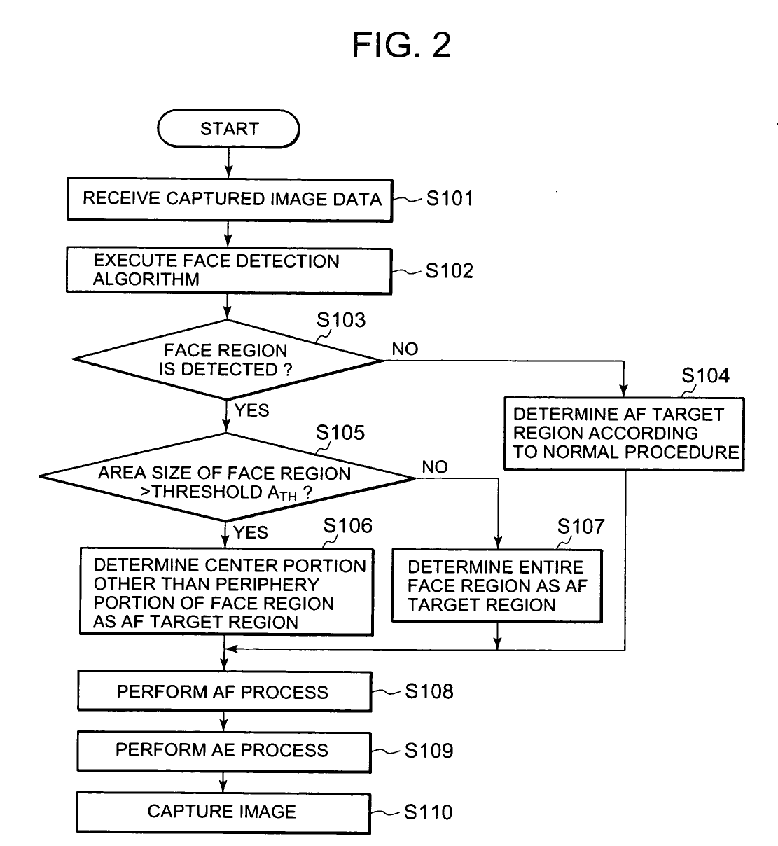

Hereinafter, detailed description will be given of a procedure of the autofocus process performed by the focusing unit 13. FIG. 2 is a flowchart showing the procedure of the autofocus process performed by the focusing unit 13. In step S101, the focusing unit 13 receives a captured image data generated by the image pickup unit 11. In step S102, the face detecting unit 130 executes the face detection algorithm to detect a face region in the received captured image data.

If the face detecting unit 130 detects no face region in step S102, the AF target region determination unit 131 determines an AF target region according to a normal processing procedure not focusing on a face region (steps S103 and S104). Here, an example of the normal processing procedure is firstly extracting, as a feature region, a high contrast region from the captured image, and then setting the feature region as the AF target region. Alternatively, the AF target region determination unit 131 may set, as the AF target region, a predetermined region in the captured image.

On the other hand, if the face detecting unit 130 detects a face region in step S102, the AF target region determination unit 131 compares the area size of the detected face region with a predetermined threshold A_{TH} (steps S103 and S105). Note that, instead of the threshold comparison on the area size of the face region, the threshold comparison may be made on another parameter representing the size of the face region, such as its horizontal and vertical lengths or the number of small regions included in the face region.

If the area size of the face region exceeds the threshold A_{TH}, the AF target region determination unit 131 determines, as an AF target region, a center portion other than a periphery portion of the face region (step S106). On the other hand, the area size of the face region is not more than the threshold A_{TH}, the AF target region determination unit 131 determines the entire face region as an AF target region (step S107).

In step S108, the focusing unit 13 performs autofocusing under the control of the controller 133 by determining the position of the focusing lens 101 so as to maximize contrast in the AF target region determined by the AF target region determination unit 131, in other words, so that a subject in the AF target region can come into focus.

Subsequent to the above autofocus process, in step S109, the focusing unit 13 performs an auto exposure (AE) process to adjust brightness of the captured image to an appropriate level. Lastly, the image pickup apparatus 1 captures another image in step S110 after the autofocus process and the auto exposure process are completed. The image data captured in step S110 is stored in a memory (not shown) after the image processor 12 performs image processing thereon. Note that, the entire process shown in FIG. 2 which includes the steps of determining an AF target region, autofocusing, auto exposuring and capturing an image may be performed, for example, in response to an operation that a camera operator presses a shutter button (not shown) provided to the image pickup apparatus 1.

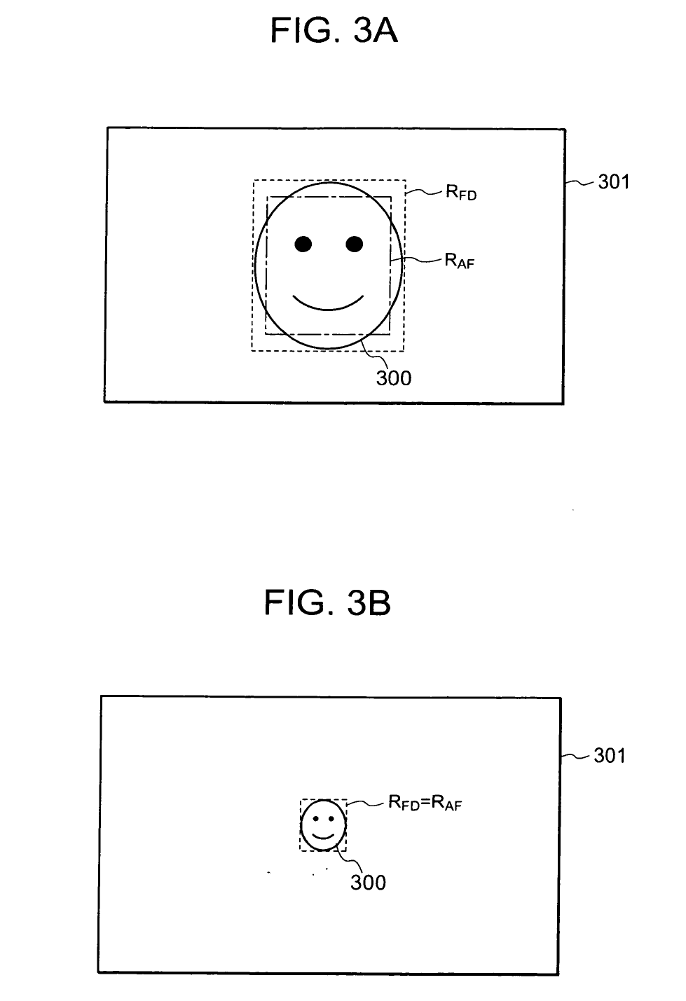

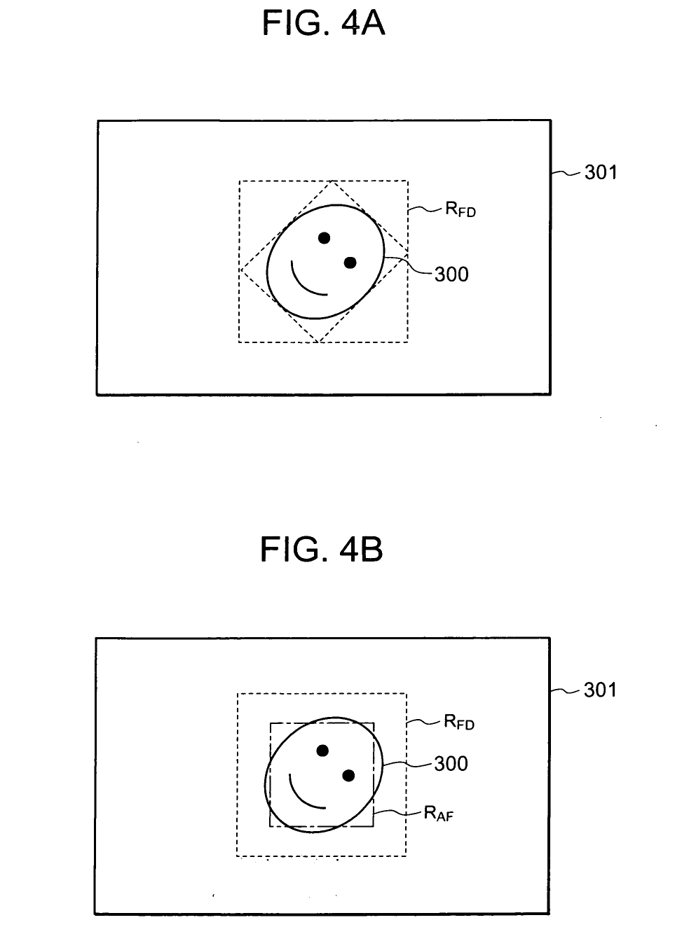

Hereinbelow, with reference to FIGS. 3A to 4B, description will be given of a specific example of an AF target region determined in steps S106 and S107 of FIG. 2. FIG. 3A shows a captured image 301 including a human face image 300. R_{FD}, a region enclosed by the dashed line in FIG. 3A, represents a face region. Meanwhile, R_{AF}, a region enclosed by the dashed-dotted line in FIG. 3A, represents an AF target region set as a center portion other than a periphery portion of the face region R_{FD}. In other words, the AF target region R_{AF} shown in FIG. 3A corresponds to an AF target region R_{AF} determined in step S106 when the area size of the face region R_{FD} exceeds the threshold A_{TH}.

As shown in FIG. 3A, when the face image 300 occupies a relatively large area in the captured image 301, a background portion other than the face image 300 also occupies a large area in the face region R_{FD}. Accordingly, autofocusing by determining, as an AF target region R_{AF}, the entire face region R_{FD} or a region larger than the face region R_{FD} might result in misfocusing. The misfocusing is a phenomenon that a background image around the face image 300 comes into focus while the face image 300 is out of focus. In this case, the image pickup apparatus 1 determines, as an AF target region R_{AF}, a center portion other than a periphery portion of the face region R_{FD}. This reduces the area size of background image included in the AF target region R_{AF}, and thus allows the image pickup apparatus 1 to perform autofocusing to maximize the contrast levels of the feature points such as eyes, a mouth, a nose, ears and eyebrows included in the face image 300.

An example of a specific procedure by which the focusing unit 13 selects an AF target region R_{AF} from a face region R_{FD} in step S106 is selecting, as the AF target region R_{AF}, a center portion of the face region R_{FD} having a similar shape as the face region R_{FD}. For example, when the face region R_{FD} is rectangular, the horizontal and vertical lengths of the AF target region R_{AF} may be preset to 80% of the horizontal and vertical lengths of the face region R_{FD} , respectively. In this case, an area ratio of the AF target region R_{AF} having a similar shape as the face region R_{FD} to the face region R_{FD} is 64%. The simple procedure of determining an AF target region R_{AF} as described above enables the determining of the AF target region R_{AF} with low computational complexity, and thus has an advantage of contributing to a faster autofocus process.

Note that, the procedure of determining an AF target region R_{AF} is not limited to the above specific example. Instead, the focusing unit 13 may determine an AF target region R_{AF} by preferentially excluding portions around the four corners of a rectangular face region R_{FD}. This procedure of determining an AF target region R_{AF} allows efficient reduction of a background portion included in the AF target region R_{AF}, for, when the face region R_{FD} is set as a rectangular shape, a background image is likely to be included around the four corners in the face region R_{FD}.

FIG. 3B shows the case in which the entire face region R_{FD} is determined as an AF target region R_{AF}. In other words, the AF target region R_{AF} shown in FIG. 3B corresponds to an AF target region R_{AF} determined in step S107 when the area size of the face region R_{FD} is not more than the threshold A_{TH}. As shown in FIG. 3A, when the face region R_{FD} is relatively small, a background portion also occupies a small area in the face region R_{FD}. Meanwhile, since the face region R_{FD} is relatively small, the image pickup apparatus 1 should not determine, as an AF target region R_{AF}, only a center portion other than a periphery portion of the face region R_{FD}. This is because this method based on an algorithm as similar to FIG. 3A might make the AF target region R_{AF} too small for the image pickup apparatus 1 to calculate a significant change in contrast evaluation values necessary for a hill-climbing control and to complete autofocusing normally.

However, the image pickup apparatus 1 has a function of changing an area ratio of a region selected as an AF target region R_{AF} to a face region R_{FD} in accordance with the size of the face region R_{FD}. In addition, the image pickup apparatus 1 is configured to select the entire face region R_{FD} as an AF target region R_{AF} when the area size of the face region R_{FD} is small. This reduces the risk that the AF target region R_{AF} will be too small to allow the successful autofocusing of the image pickup apparatus 1.

FIG. 4A shows the case in which a human face image 300 included in the captured image 301 is tilted. In this case, when the face region R_{FD} is determined by outline correction, a background portion other than the face image 300 occupies a large area in the face region R_{FD} as shown in FIG. 4A. Thus, when such a tilted face image 300 is detected, the image pickup apparatus 1 may determine, as an AF target region R_{AF}, a center portion of the face region R_{FD} as shown in FIG. 4B. Note, however, that an area ratio of as an AF target region R_{AF} to a face region R_{FD} should preferably be set smaller than in the case of FIG. 3A such that a background portion in the face region R_{FD} can be efficiently removed.

As described above, the image pickup apparatus 1 according to this embodiment sets an AF target region within a face region obtained by face detection. In addition, depending on whether or not the area size of the face region exceeds a threshold A_{TH}, the image pickup apparatus 1 sets the AF target region to either a center portion other than a periphery portion of the face region or the entire face region. In other words, the image pickup apparatus 1 is configured to change the area ratio of the AF target region to the entire face region in accordance with the size of the face region. Accordingly, when the face region is relatively large, the area ratio of the AF target region is reduced so that an adverse effect of a background portion therein can be controlled and that misfocusing can thus be made less likely to occur. Meanwhile, when the face region is relatively small, the area ratio of the AF target region is increased so that the large AF target region can be secured and that the contrast detection system can thus become less likely to fail to autofocus.

Incidentally, the processes performed by the face detecting unit 130, the AF target region determination unit 131 and the controller 133 shown in FIG. 1 can be implemented by causing a memory for storing captured image data and a computer having a central processing unit (CPU) to execute a program describing the process procedure of steps S101 to S107 of FIG. 2.

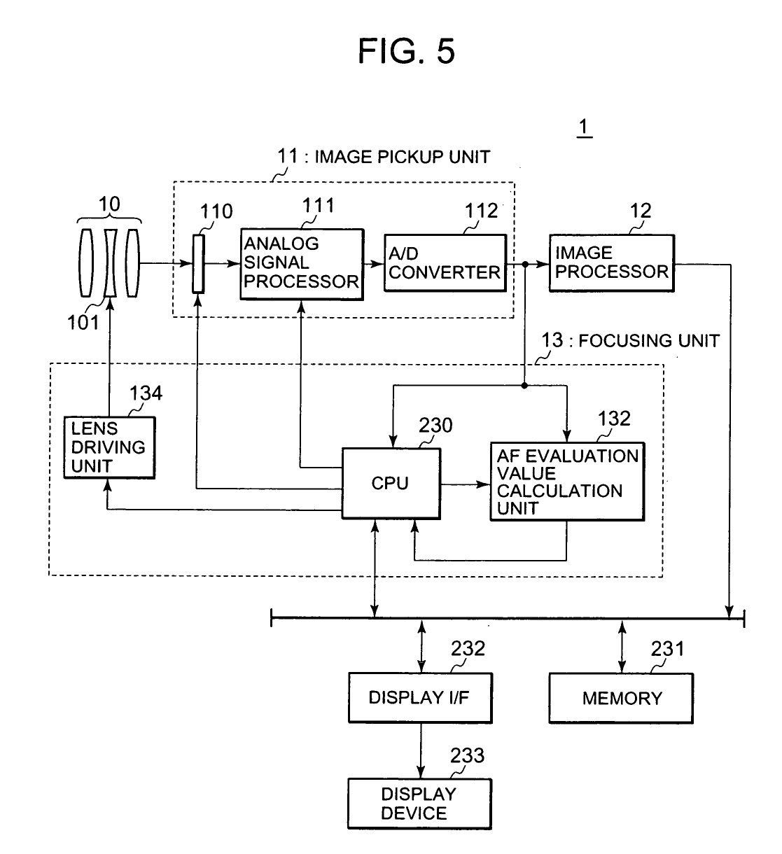

FIG. 5 shows a specific configuration example of the image pickup apparatus 1 containing CPU. The configuration diagram of FIG. 5 shows constituents, such as a display device, useful in applying the image pickup apparatus 1 in a digital camera product in addition to the main configuration of the image pickup apparatus 1 shown in FIG. 1. In FIG. 5, a CPU 230 performs the processes assigned to the face detecting unit 130, the AF target region determination unit 131 and the controller 133 by reading out and executing a program stored in a memory 231. The memory 231 is a memory set of a nonvolatile memory such as a read-only memory (ROM) or a flash memory and a volatile memory such as a dynamic random access memory (DRAM). The memory 231 stores therein the program executed by the CPU 230, captured image data and the like. A display device 233 displays an image supplied through a display interface 232. The display device 233 displays: captured images (through image) sequentially outputted by the image pickup unit 11; a face region detected by executing the face detection algorithm; through image after autofocusing is completed; and captured images captured when the camera operator operates a shutter button (not shown) Needless to say, the CPU 230 may execute calculation of AF evaluation values in place of the AF evaluation value calculation unit 132.

### Second Embodiment

In the above first embodiment, description will be given of the configuration in which, depending on whether or not the area size of the face region exceeds a threshold A_{TH}, the AF target region is set to either a center portion other than a periphery portion of the face region or the entire face region. However the first embodiment is only a specific example of an image pickup apparatus capable of changing the area ratio of an AF target region to a face region in accordance with the size of the face region. An image pickup apparatus according to a second embodiment is another example of an image pickup apparatus capable of changing the area ratio of an AF target region to a face region in accordance with the size of the face region.

A configuration of the image pickup apparatus according to this embodiment may be set similar to that of the image pickup apparatus 1 shown in FIGS. 1 and 5. Accordingly, the configuration diagram of the image pickup apparatus according to this embodiment will not be redundantly presented, and the detailed description thereof will be omitted. In addition, in the following description, constituents of the image pickup apparatus according to this embodiment are referred by using reference numerals assigned to the constituents of the image pickup apparatus 1 shown in FIG. 1 or 5.

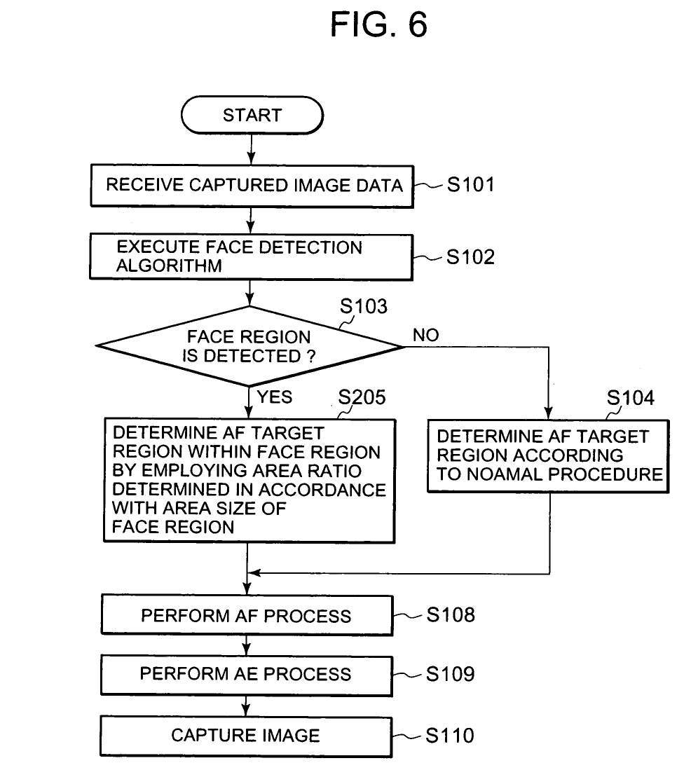

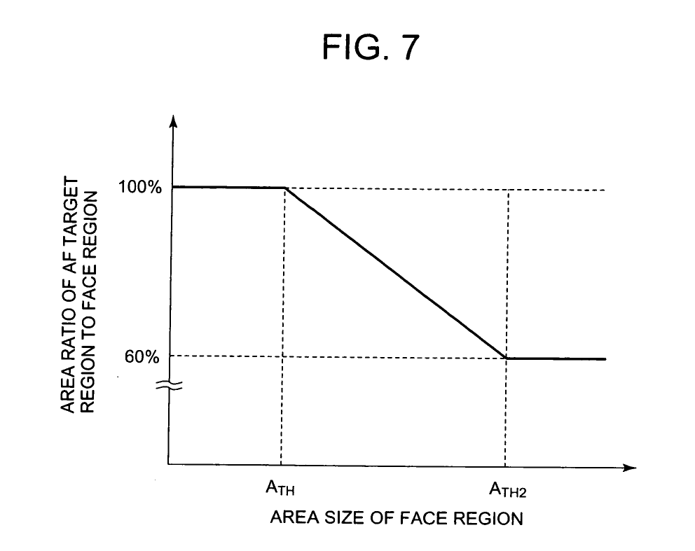

FIG. 6 shows the procedure of the autofocus process performed by the focusing unit 13 included in the image pickup apparatus according to this embodiment. The flowchart shown in FIG. 6 is different from the flowchart shown in FIG. 2 in that steps S105 to S107 are replaced with step S205. In Step S205, which is performed if the face detecting unit 130 detects a face region, the AF target region determination unit 131 determines an AF target region within the face region by employing an area ratio of the AF target region R_{AF} determined in accordance with the size of the detected face region. FIG. 7 is a graph showing a size relationship between an AF target region determined in step S205 and a face region. The horizontal axis of the graph shown in FIG. 7 represents the area size of the face region while the vertical axis of the graph represents the area ratio of the AF target region to the face region.

In the example shown in FIG. 7, if the area size of the face region is not more than the threshold A_{TH}, the area ratio of the AF target region is determined as 100%, that is, the entire face region is determined as the AF target region. Meanwhile, if the area size of the face region is in the range between the threshold A_{TH} and a second threshold A_{TH2}, which is larger than the threshold A_{TH}, the AF target region is determined such that the area ratio of the AF target region to the face region can become smaller with the increase in the area size of the face region. If the area size of the face region exceeds the threshold A_{TH2}, the area ratio of the AF target region to the face region is set to a predetermined lower limit. As an example, the lower limit of the area ratio is set to 60% in FIG. 7.

### Other Embodiments

In the above embodiments according to the present invention, an imaging location of the subject image is adjusted by moving the focusing lens 101 included in the shooting optical system 10, as an example. However, the imaging location of the subject image may be adjusted by moving the image pickup device 110.

Moreover, in the above first embodiment according to the present invention, the area ratio of an AF target region to a face region is set to either of two values based on comparison result of the size of the face region with a single threshold A_{TH}, as an example. However, two or more thresholds may be set for the size of the face region, and the area ratio of an AF target region determined in accordance with the size of the face region may be set to either of three or more values.

In the above embodiments according to the present invention, a configuration is described in which, when a face region is relatively large, a center portion other than a periphery portion of the face region is determined as an AF target region. Note, however, that this configuration is not intended to completely remove a background from the AF target region. In other words, an AF target region determined by the image pickup apparatuses of the above embodiments according to the present invention might include a background image. The present invention does not exclude selection of an AF target region including a background image.

It is apparent that the present invention is not limited to the above embodiments, but may be modified and changed without departing from the scope and spirit of the invention.

What is claimed is:

1. An autofocus control circuit, comprising:
face detection part for determining a face region including a face of an subject image based on captured image data generated by capturing said subject image formed by a shooting optical system;
autofocus target region determination part for determining an autofocus target region within said face region, said autofocus target region determination part is capable of changing an area ratio of said autofocus target region to said face region; and
focusing condition determination part for determining a focusing condition of said subject image based on contrast in a region, corresponding to said autofocus target region, of said captured image data.

2. The autofocus control circuit according to claim 1, wherein said autofocus target region determination part changes said area ratio based on a size of said face region.

3. The autofocus control circuit according to claim 1, wherein said autofocus target region determination part determines said autofocus target region such that said area ratio becomes larger with decreasing said size of said face region.

4. The autofocus control circuit according to claim 1, wherein said autofocus target region determination part sets, as said autofocus target region, a center portion other than a periphery portion of said face region if said size of said face region exceeds a predetermined value, and
said autofocus target region determination part sets, as said autofocus target region, the entire face region if said size of said face region is not more than said predetermined value.

5. The autofocus control circuit according to claim 1, wherein said autofocus target region determination part sets, as said autofocus target region, a region obtained by reducing said face region based on said area ratio.

6. The autofocus control circuit according to claim 5, wherein said autofocus target region determination part makes said autofocus target region have a shape similar to said face region.

7. The autofocus control circuit according to claim 1, wherein
said face region is rectangular, and
said autofocus target region determination part preferentially excludes, from said autofocus target region, portions around four corners of said face region in determining said autofocus target region within said face region.

8. An autofocus control method for an image pickup apparatus including image pickup part for generating captured image data by capturing an image of a subject image formed by a shooting optical system, comprising:
determining a face region including a face of said subject image based on said captured image data;
determining an autofocus target region within said face region by changing an area ratio of said autofocus target region to said face region; and
adjusting an imaging location of said subject image based on contrast in a region, corresponding to said autofocus target region, of said captured image data.

9. The autofocus control method according to claim 8, wherein said area ratio is changed based on a size of said face region.

10. The autofocus control method according to claim 8, wherein said autofocus target region is determined such that said area ratio of said autofocus target region to said face region becomes larger with decreasing said size of said face region.

11. The autofocus control method according to claim 8, wherein
said autofocus target region is set to a center portion other than a periphery portion of said face region if said size of said face region exceeds a predetermined value, and
said autofocus target region is set to the entire face region if said size of said face region is not more than said predetermined value.

12. The autofocus control method according to claim 8, wherein said autofocus target region is set to a region obtained by reducing said face region based on said area ratio.

13. The autofocus control method according to claim 12, wherein said autofocus target region is made to have a shape similar to said face region.

14. An image pickup apparatus, comprising:
a shooting optical system;
image pickup part for generating captured image data by capturing an subject image formed by the shooting optical system;
face detection part for determining a face region including a face of said subject image based on said captured image data;
autofocus target region determination part for determining an autofocus target region within said face region, said autofocus target region determination part is capable of changing an area ratio of said autofocus target region to said face region; and
autofocus part for adjusting an imaging location of said subject image based on contrast in a region, corresponding to said autofocus target region, of said captured image data.

15. The image pickup apparatus according to claim 14, wherein said autofocus target region determination part changes said area ratio based on a size of said face region.

16. The image pickup apparatus according to claim 14, wherein said autofocus target region determination part determines said autofocus target region such that said area ratio becomes larger with decreasing said size of said face region.

17. The image pickup apparatus according to claim 14, wherein
said autofocus target region determination part sets, as said autofocus target region, to a center portion other than a periphery portion of said face region if said size of said face region exceeds a predetermined value, and
said autofocus target region determination part sets, as said autofocus target region, to the entire face region if said size of said face region is not more than said predetermined value.
